(19) United States
(12) Patent Application Publication
(10) Pub. No.: US 2024/0146102 A1
(43) Pub. Date: May 2, 2024

(54) RETENTION LID FOR WIRELESS CHARGING PAD

(71) Applicant: GM GLOBAL TECHNOLOGY OPERATIONS LLC, Detroit, MI (US)

(72) Inventors: Brian M. Stoeckel, Detroit, MI (US); Dinesh Adimulam Naicker, Rochester Hills, MI (US)

(21) Appl. No.: 17/974,724

(22) Filed: Oct. 27, 2022

(51) Int. Cl. H02J 50/00

(52) U.S. Cl. CPC H02J 50/005; H02J 50/10

(57) ABSTRACT

Aspects of the disclosure include a retention system for securing an electronic device when wirelessly charging the electronic device. An exemplary retention system can include a wireless charging pad having a charging surface adapted to receive the electronic device. The wireless charging pad can be configured for wireless power transfer to the electronic device when the electronic device is placed on the charging surface. A retention lid is coupled to the wireless charging pad at a biased hinge. The biased hinge includes a crossbar and a spring wound around the crossbar. The spring exerts a tension on the retention lid. A gripping feature is positioned between the retention lid and the wireless charging pad. The gripping feature includes one or more molded features that extend towards the wireless charging pad. The molded features include a material that depresses upon contact with the electronic device.

### INTRODUCTION

The subject disclosure relates to wireless charging technologies, and particularly to a retention lid for a wireless charging pad in automotive applications.

Electronic devices such as smartphones and laptops have become ubiquitous with daily life. These devices generally include a battery for portability, and the battery needs to be charged periodically. Convenient charging solutions have become highly desirable as the amount of time spent using these devices, and consequently battery demand, has increased. In-vehicle (onboard) device charging solutions, for example, allow a user to conveniently recharge their device while driving or riding in a vehicle. For example, various wired charging systems leverage an alternating current (AC) adapter, a Universal Serial Bus (USB) port, and/or a lighter barrel-style connector to draw power from the vehicle to recharge an electronic device.

Recently, with the development of wireless power transfer (WPT) technologies, electronic devices equipped with on-board wireless charging solutions have been commercialized and have become somewhat widespread. Wireless charging-enabled devices offer further increases in convenience by avoiding the need for cumbersome wires altogether. Wireless charging is particularly convenient in automotive applications, as the wires required for conventional wired charging can become tangled while the vehicle is in use.

### SUMMARY

In one exemplary embodiment a retention system for securing an electronic device when wirelessly charging the electronic device can include a wireless charging pad having a charging surface adapted to receive the electronic device. The wireless charging pad can be configured for wireless power transfer to the electronic device when the electronic device is placed on the charging surface. A retention lid is coupled to the wireless charging pad at a biased hinge. The biased hinge includes a crossbar and a spring wound around the crossbar. The spring exerts a tension on the retention lid. A gripping feature is positioned between the retention lid and the wireless charging pad. The gripping feature includes one or more molded features that extend towards the wireless charging pad. The molded features include a material that depresses upon contact with the electronic device.

In addition to one or more of the features described herein, in some embodiments, the wireless charging pad includes a first extension feature having a first through hole and the retention lid includes a second extension feature having a second through hole. In some embodiments, the crossbar is inserted through the first through hole and the second through hole to rotatably secure the retention lid to the wireless charging pad about the biased hinge.

In some embodiments, the gripping feature is coupled to a portion of the retention lid. In some embodiments, when the retention lid is closed over the electronic device on the wireless charging pad, the retention lid exerts pressure on the electronic device. In some embodiments, the pressure exerted on the electronic device by the retention lid is proportional to a spring constant of the spring.

In some embodiments, the material of the one or more molded features includes molded rubber.

In some embodiments, the retention lid includes a leading edge that is tapered such that only an end portion of the electronic device is covered by the retention lid when the retention lid is closed over the electronic device.

In some embodiments, an extent to which the one or more molded features extend from the retention lid to the wireless charging pad defines a gap between the retention lid and the wireless charging pad into which the electronic device can be placed. In some embodiments, a height of the gap changes upon contact with the electronic device due to compression of the one or more molded features.

In another exemplary embodiment a vehicle includes a passenger compartment having a center console region and a retention system embedded in the center console region. The retention system can include a wireless charging pad having a charging surface adapted to receive the electronic device. The wireless charging pad can be configured for wireless power transfer to the electronic device when the electronic device is placed on the charging surface. A retention lid is coupled to the wireless charging pad at a biased hinge. The biased hinge includes a crossbar and a spring wound around the crossbar. The spring exerts a tension on the retention lid. A gripping feature is positioned between the retention lid and the wireless charging pad. The gripping feature includes one or more molded features that extend towards the wireless charging pad. The one or more molded features include a material that depresses upon contact with the electronic device.

In yet another exemplary embodiment a method for securing an electronic device when wirelessly charging the electronic device can include providing a wireless charging pad having a charging surface adapted to receive the electronic device. The wireless charging pad can be configured for wireless power transfer to the electronic device when the electronic device is placed on the charging surface. The method can include coupling a retention lid to the wireless charging pad at a biased hinge. The biased hinge includes a crossbar and a spring wound around the crossbar. The spring exerts a tension on the retention lid. A gripping feature is positioned between the retention lid and the wireless charging pad. The gripping feature includes one or more molded features that extend towards the wireless charging pad. The one or more molded features include a material that depresses upon contact with the electronic device.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a perspective view of a passenger compartment of a vehicle in accordance with one or more embodiments;

FIG. 2 is a perspective view of the wireless charging pad and retention lid shown in FIG. 1 in accordance with one or more embodiments;

FIG. 3A depicts the retention lid shown in FIG. 2 in accordance with one or more embodiments;

FIG. 3B depicts the gripping feature shown in FIG. 2 in accordance with one or more embodiments;

FIG. 3C depicts the wireless charging pad shown in FIG. 2 in accordance with one or more embodiments;

FIG. 4 is a cut-away view of the wireless charging pad and retention lid shown in FIG. 2 in accordance with one or more embodiments;

FIG. 5. is a computer system according to one or more embodiments; and

FIG. 6 is a flowchart in accordance with one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

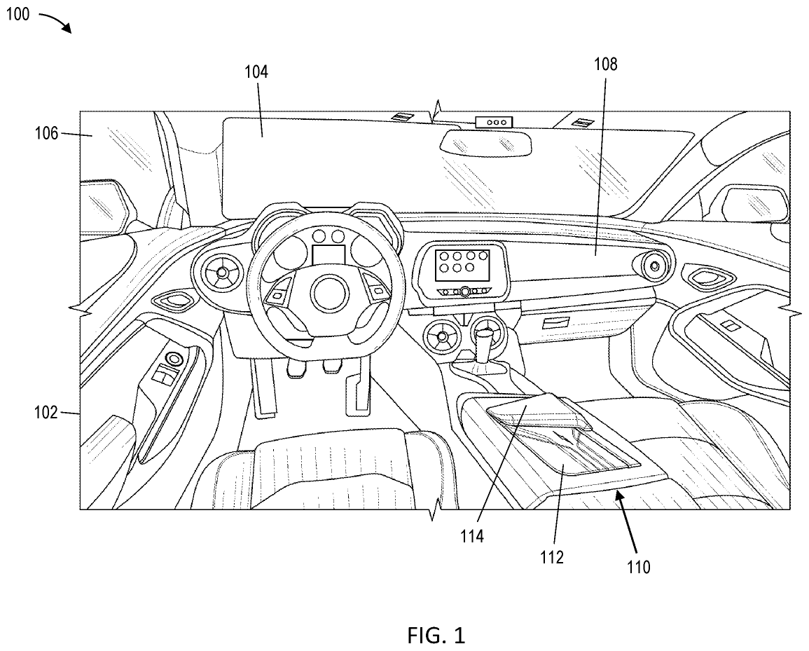

FIG. 1 illustrates a perspective view of a passenger compartment 100 of a vehicle in accordance with one or more embodiments. As shown in FIG. 1, the passenger compartment 100 includes a body 102 within which are arranged various components, including, for example, a steering wheel, front seats, rear passenger seats (not separately shown), various glass panels (e.g., a front windshield 104, a driver-side window 106, etc.), a dashboard 108 (including various instrument panels), and a center console region 110. As will be detailed herein, the center console region 110 (also referred to as a forward console area) includes a wireless charging pad 112 having thereon secured a retention lid 114. The wireless charging pad 112 is not meant to be particularly limited, but generally includes various components configured for wireless power transfer (WPT). For example, the wireless charging pad 112 can include inductive charging pads which may employ magnetic induction or resonating coils for wireless power delivery.

The wireless charging pad 112 and retention lid 114 are shown incorporated within the center console region 110 for ease of illustration and discussion only, and it should be understood that a wireless charging pad and retention lid configured according to one or more embodiments can be incorporated within any structure of the passenger compartment 100. For example only, a wireless charging pad and retention lid configured according to one or more embodiments can be incorporated within the dashboard, the driver-side and/or passenger-side door, rear passenger doors, a rear seat console, a headrest, and the like, and all such configurations are within the contemplated scope of this disclosure. While the passenger compartment 100 is shown having a single wireless charging pad and retention lid, other configurations having two or more separate (or physically adjacent and/or coupled) wireless charging pads and respective retention lids are possible. It should be further appreciated that the relative sizing of the wireless charging pads and respective retention lids can be changed as desired to accommodate the available area within the respective structures of the passenger compartment 100 into which the wireless charging pads and respective retention lids are incorporated. Again, all such configurations are within the contemplated scope of this disclosure.

As discussed previously, onboard wireless charging solutions offer consumers a convenient means to recharge their electronic devices while driving without requiring cumbersome wires. Unfortunately, in-vehicle wireless chargers must find a balance between ease of use (e.g., maintaining sight and ease of access) and enabling the phone to be secured from moving during normal driving situations. For example, a phone placed on a horizontal charging pad can easily slip during acceleration and braking maneuvers, even in typical driving scenarios. In today's vehicles, wireless phone chargers are often placed at an awkward angle (even facing away from the customer entirely) or are buried within a storage bin recess to prevent the phone from moving while the vehicle is operated.

This disclosure introduces a way to secure an electronic device to a wireless charging pad without sacrificing ease of use. Rather than positioning the wireless charging pad in a recess and/or storage bin, wireless charging pads configured according to one or more embodiments include a retention lid for securing the electronic device to the wireless charging pad. The retention lid is configured to grab an end portion of the electronic device (e.g., a smartphone), leaving most of the electronic device, including the touch screen, unobscured and visible.

In some embodiments, an electronic device is retained in place by tension on a spring positioned at a forward edge between the retention lid and the wireless charging pad. The spring tension on the retention lid can be adjusted as needed to prevent the electronic device from sliding out of place during normal and spirited driving environments. In some embodiments, the spring is coupled to a biased hinge between the retention lid and wireless charging pad, and about which the retention lid can rotate between open and closed positions. In some embodiments, the biased hinge includes one or more through holes or pins and a crossbar for securing the spring to the retention lid and/or wireless charging pad. Working together, the biased hinge and spring provide downward pressure on the electronic device when the spring-loaded retention lid is in the closed position, holding the electronic device in place.

In some embodiments, the underside of the retention lid (i.e., the surface directly opposite to an electronic device, when present) includes gripping features to aid in retaining the electronic device in the position it was placed by the user. The gripping features can include, for example, one or more molded rubber features. The gripping features can be constructed to extend from the retention lid such that a flexible contact can be made to an electronic device when the retention lid is closed over the wireless charging pad. For example, the gripping features can be designed from materials that depress or otherwise compress upon contact with an electronic device. In this manner, electronic devices having a variety of sizes and thicknesses can be accommodated without changing the tension on the spring or the size and/or position of the retention lid.

Wireless charging pads and retention lids constructed in accordance with one or more embodiments offer several technical advantages over prior onboard wireless charging solutions. In particular, wireless charging pads and retention lids described herein enable a driver's or passenger's phone to be placed conveniently within the center console (or on any other surface of the vehicle), remaining visible to the user while also being retained and stable during even spirited driving. Moreover, retention lids constructed according to one or more embodiments allow for electronic devices having a variety of sizes and thicknesses, with and without cases, to be secured to the wireless charging pad. This improves the usability and function of onboard wireless chargers for a range of electronic devices (e.g., smartphones, tablets, laptops, etc.).

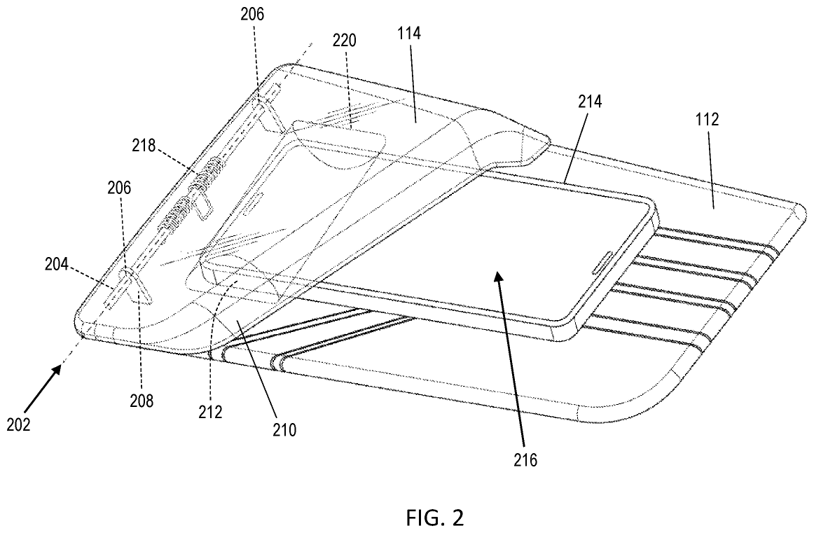

FIG. 2 illustrates a perspective view of the wireless charging pad 112 and retention lid 114 shown in FIG. 1 in accordance with one or more embodiments. As shown in FIG. 2, the retention lid 114 can be fixed to the wireless charging pad 112 by way of a biased hinge 202. The configuration of the biased hinge 202 is not meant to be particularly limited. In some embodiments, the biased hinge 202 includes a crossbar 204 that is insertably coupled to one or more extension features 208 via through holes 206 attached to the wireless charging pad 112 and retention lid 114. The through holes 206 can be positioned to align with the biased hinge 202. In this manner, the wireless charging pad 112 can be fixed to the retention lid 114 by inserting the crossbar 204 through the through holes 206. Other configurations are possible, and all such configurations are within the contemplated scope of this disclosure.

As further shown in FIG. 2, the retention lid 114 can include a leading edge 210. In some embodiments, the leading edge 210 is configured such that only an end portion 212 of an electronic device 214 is covered by the retention lid 114. In some embodiments, the leading edge 210 is tapered (as shown), although other configurations including various degrees of taper, or no taper at all, are within the contemplated scope of this disclosure. Advantageously, configuring the leading edge 210 to cover only the end portion 212 of the electronic device 214 allows for a substantial exposed portion 216 of the electronic device 214 to remain uncovered, improving visibility and ease of use.

In some embodiments, the biased hinge 202 includes a spring 218. In some embodiments, the spring 218 can be wound around the crossbar 204 (as shown), although other configurations are possible. In some embodiments, the spring 218 exerts tension (according to its spring constant) on the retention lid 114. In this manner, the retention lid 114 can exert pressure on the electronic device 214, holding the electronic device 214 in place. It should be understood that the pressure exerted on the electronic device 214 is proportional to the spring constant of the spring 218. Accordingly, the materials, number of coils, thickness, and/or other properties of the spring 218 can be adjusted to change the spring constant as desired, thus adapting the retention pressure as needed for a particular application.

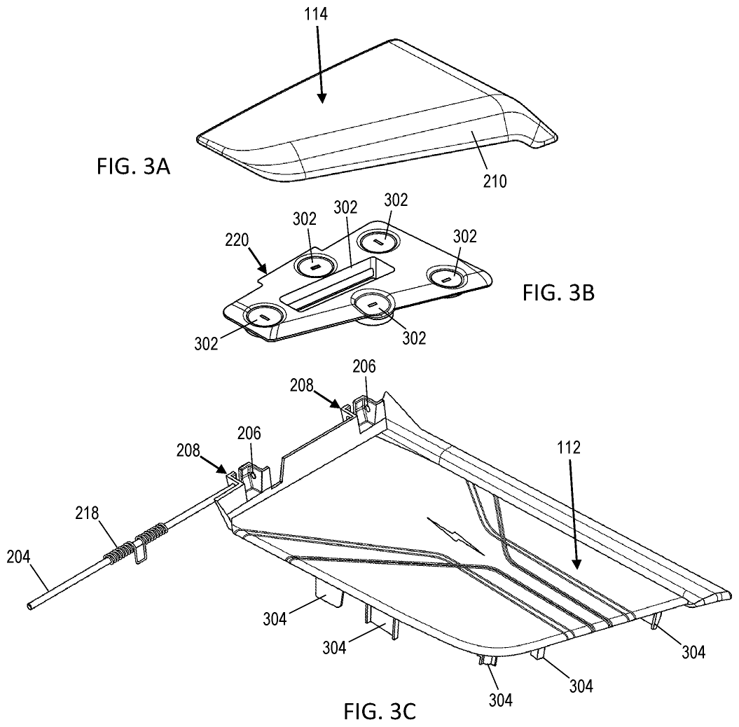

In some embodiments, a gripping feature 220 is positioned between the retention lid 114 and the wireless charging pad 112. In some embodiments, the gripping feature 220 is part of, or attached to, an underside portion of the retention lid 114. The gripping feature 220 is discussed in further detail with respect to FIG. 3B.

FIGS. 3A, 3B, and 3C illustrate portions of a disassembled view of the wireless charging pad 112 and retention lid 114 shown in FIG. 2 in accordance with one or more embodiments. In particular, FIG. 3A depicts the retention lid 114, FIG. 3B depicts the gripping feature 220, and FIG. 3C depicts the wireless charging pad 112, in accordance with one or more embodiments.

As shown in FIG. 3B, the gripping feature 220 can be positioned between the retention lid 114 and the wireless charging pad 112. In some embodiments, the gripping feature 220 is a part of, or attached to, an underside portion of the retention lid 114, although other configurations are possible. In some embodiments, the gripping feature 220 is made of a pliable material, such as, for example, rubber, silicon, and various epoxies, such as flexible epoxy resin. For example, the gripping feature 220 can include molded rubber. The particular materials selected for the gripping feature 220 is not meant to be particularly limited.

In some embodiments, the gripping feature 220 includes one or more molded features 302 to assist in retaining an electronic device on the wireless charging pad 112. In some embodiments, the molded features 302 are molded rubber features, however, the materials selected for the molded features 302 need not be so limited. The molded features 302 can be made of a same or different material as the gripping feature 220. As shown in FIG. 3B, the gripping feature 220 can include six molded features 302, although the number of molded features 302 can vary as desired and is not meant to be particular limited. In some embodiments, two or more of the molded features 302 can be made of a same or substantially identical shape, while one or more of the molded features 302 can be made of a different shape. For example, five of the molded features 302 can be configured as circular protrusions that extend towards the wireless charging pad 112, while one (or more) of the molded features 302 can be configured as a bumper, bar, or other type of protrusion that extends towards the wireless charging pad 112 (as shown).

In some embodiments, the molded features 302 are configured to extend from the retention lid 114 such that a flexible contact can be made to an electronic device when the retention lid 114 is closed over the wireless charging pad 112. In some embodiments, the molded features 302 are made of a thin, flexible material such that the molded features 302 depress or otherwise compress upon contact with an electronic device placed on the wireless charging pad 112 when the retention lid 114 is in the closed position. In this manner, the wireless charging pad 112 and the retention lid 114 can accommodate electronic devices having a variety of sizes and thicknesses.

As shown in FIG. 3C, the wireless charging pad 112 can include a plurality of connecting features 304 configured to secure the wireless charging pad 112 to a surface, such as, for example only, the center console region 110 of the vehicle shown in FIG. 1. The connecting features 304 shown in FIG. 3C are for example only, and any configuration, arrangement, and number of connecting features 304 can be provided as desired. In addition, or alternatively, one or more of the connecting features 304 can extend from the underlying surface (not separately shown) to attach to the wireless charging pad 112.

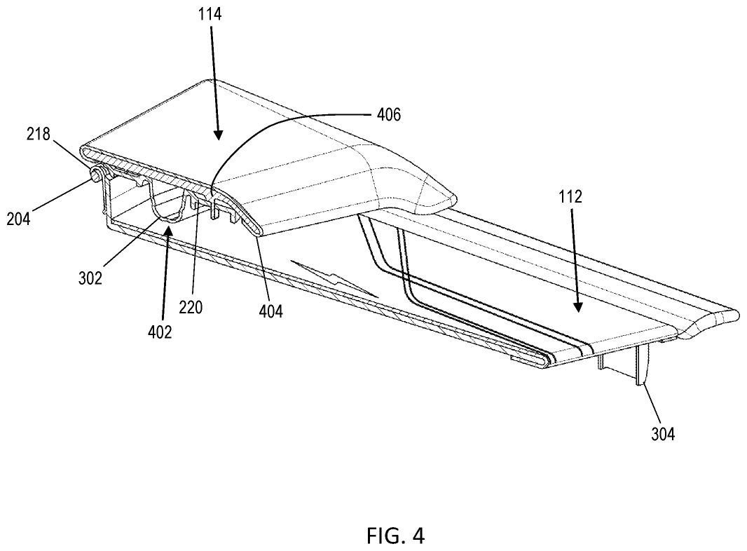

FIG. 4 illustrates a cut-away view of the wireless charging pad 112 and retention lid 114 shown in FIG. 2 in accordance with one or more embodiments. As shown in FIG. 4, one or more of the molded features 302 extend from the retention lid 114 towards the wireless charging pad 112. The extent to which the molded features 302 extend from the retention lid 114 can vary as desired and defines a gap 402 between the retention lid 114 and the wireless charging pad 112 into which an electronic device can be placed. As discussed previously, the molded features 302 can be made of flexible materials, and consequently, the height of the gap 402 changes upon contact with an electronic device due to compression of the molded features 302.

As further shown in FIG. 4, the retention lid 114 can include an outer layer 404 and one or more inner layers 406. In some embodiments, the outer layer 404 is made of a durable material such as leather, synthetic leather, plastic, fabric, and the like, although the materials selected for the outer layer 404 are not meant to be particularly limited. In some embodiments, the one or more inner layers 406 are made of a same or different material as the outer layer 404. For example, the one or more inner layers 406 can be made of plastics and/or metals, although the materials selected for the one or more inner layers 406 are not meant to be particularly limited. In some embodiments, a portion of the outer layer 404 and/or a portion of the one or more inner layers 406 can wrap around or otherwise fix the gripping feature 220 to the retention lid 114.

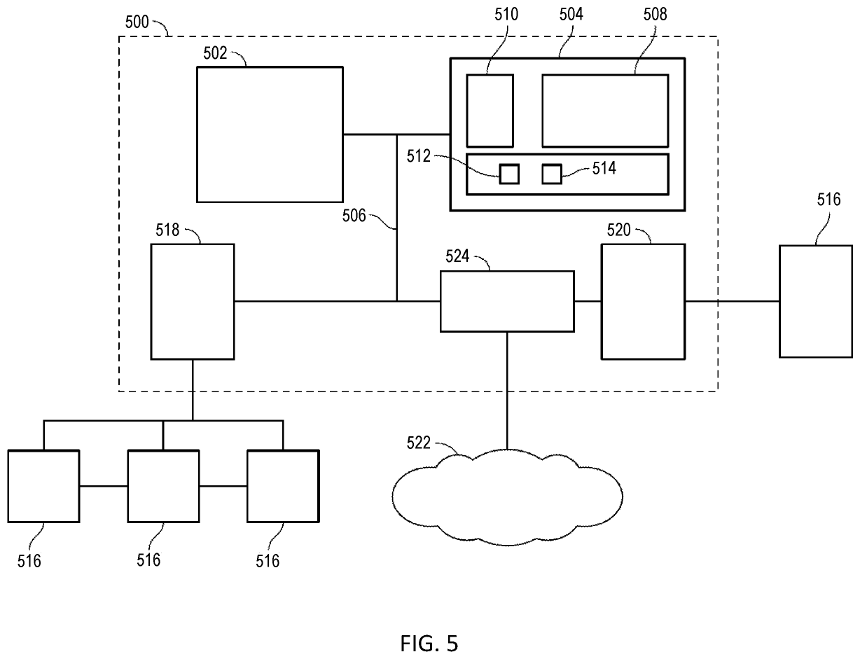

FIG. 5 illustrates aspects of an embodiment of a computer system 500 that can perform various aspects of embodiments described herein. In some embodiments, the computer system 500 can be incorporated within or in combination with a wireless charging pad (e.g., the wireless charging pad 112). The computer system 500 includes at least one processing device 502, which generally includes one or more processors for performing a variety of functions, such as, for example, controlling wireless power delivery to one or more electronic devices placed on the wireless charging pad 112. More specifically, the computer system 500 can include the logic necessary to direct wireless power to the one or more electronic devices placed on the wireless charging pad 112.

Components of the computer system 500 include the processing device 502 (such as one or more processors or processing units), a system memory 504, and a bus 506 that couples various system components including the system memory 504 to the processing device 502. The system memory 504 may include a variety of computer system readable media. Such media can be any available media that is accessible by the processing device 502, and includes both volatile and non-volatile media, and removable and non-removable media.

For example, the system memory 504 includes a non-volatile memory 508 such as a hard drive, and may also include a volatile memory 510, such as random access memory (RAM) and/or cache memory. The computer system 500 can further include other removable/non-removable, volatile/non-volatile computer system storage media.

The system memory 504 can include at least one program product having a set (e.g., at least one) of program modules that are configured to carry out functions of the embodiments described herein. For example, the system memory 504 stores various program modules that generally carry out the functions and/or methodologies of embodiments described herein. A module or modules 512, 514 may be included to perform functions related to control of the wireless charging pad 112, such as, for example, determining a current charging rate for wireless power delivery, a current charge state for one or more electronic devices, a charging duration, a charging current and/or voltage, etc. The computer system 500 is not so limited, as other modules may be included depending on the desired functionality of the respective wireless charging pad. As used herein, the term “module” refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality. For example, the module(s) can be configured via software, hardware, and/or firmware to cause a wireless charging pad (the wireless charging pad 112) to supply power wirelessly to an electronic device.

The processing device 502 can also be configured to communicate with one or more external devices 516 such as, for example, a keyboard, a pointing device, and/or any devices (e.g., a network card, a modem, vehicle ECUs, etc.) that enable the processing device 502 to communicate with one or more other computing devices. Communication with various devices can occur via Input/Output (I/O) interfaces 518 and 520.

The processing device 502 may also communicate with one or more networks 522 such as a local area network (LAN), a general wide area network (WAN), a bus network and/or a public network (e.g., the Internet) via a network adapter 524. In some embodiments, the network adapter 524 is or includes an optical network adaptor for communication over an optical network. It should be understood that although not shown, other hardware and/or software components may be used in conjunction with the computer system 500. Examples include, but are not limited to, microcode, device drivers, redundant processing units, external disk drive arrays, RAID systems, and data archival storage systems, etc.

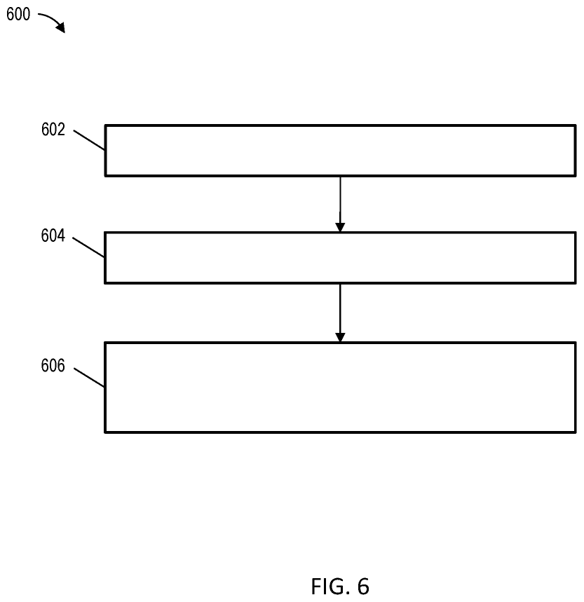

Referring now to FIG. 6, a flowchart 600 for securing an electronic device to a wireless charging pad is generally shown according to an embodiment. The flowchart 600 is described in reference to FIGS. 1 to 5 and may include additional steps not depicted in FIG. 6. Although depicted in a particular order, the blocks depicted in FIG. 6 can be rearranged, subdivided, and/or combined.

At block 602, a wireless charging pad is provided. The wireless charging pad can include a charging surface adapted to receive the electronic device. The wireless charging pad can be configured for wireless power transfer to the electronic device when the electronic device is placed on the charging surface.

At block 604, a retention lid is coupled to the wireless charging pad at a biased hinge. The biased hinge includes a crossbar and a spring wound around the crossbar. The spring exerts a tension on the retention lid.

At block 606, a gripping feature is positioned between the retention lid and the wireless charging pad. The gripping feature includes one or more molded features that extend towards the wireless charging pad. The one or more molded features include a material, such as molded rubber, that depresses upon contact with the electronic device.

In some embodiments, the wireless charging pad includes a first extension feature having a first through hole and the retention lid comprises a second extension feature having a second through hole. In some embodiments, the crossbar is inserted through the first through hole and the second through hole to rotatably secure the retention lid to the wireless charging pad about the biased hinge.

In some embodiments, when the retention lid is closed over the electronic device on the wireless charging pad, the retention lid exerts pressure on the electronic device. In some embodiments, the pressure exerted on the electronic device by the retention lid is proportional to the spring constant of the spring.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof

What is claimed is:

1. A retention system for securing an electronic device when wirelessly charging the electronic device, the retention system comprising:
a wireless charging pad comprising a charging surface adapted to receive the electronic device, the wireless charging pad configured for wireless power transfer to the electronic device when the electronic device is placed on the charging surface;
a retention lid coupled to the wireless charging pad at a biased hinge, the biased hinge comprising a crossbar and a spring wound around the crossbar, wherein the spring exerts a tension on the retention lid; and
a gripping feature positioned between the retention lid and the wireless charging pad, the gripping feature comprising one or more molded features that extend towards the wireless charging pad, the one or more molded features comprising a material that depresses upon contact with the electronic device.

2. The retention system of claim 1, wherein the wireless charging pad comprises a first extension feature having a first through hole and the retention lid comprises a second extension feature having a second through hole.

3. The retention system of claim 2, wherein the crossbar is inserted through the first through hole and the second through hole to rotatably secure the retention lid to the wireless charging pad about the biased hinge.

4. The retention system of claim 1, wherein the gripping feature is coupled to a portion of the retention lid.

5. The retention system of claim 1, wherein, when the retention lid is closed over the electronic device on the wireless charging pad, the retention lid exerts pressure on the electronic device.

6. The retention system of claim 5, wherein the pressure exerted on the electronic device by the retention lid is proportional to a spring constant of the spring.

7. The retention system of claim 1, wherein the material of the one or more molded features comprises molded rubber.

8. The retention system of claim 1, wherein the retention lid comprises a leading edge that is tapered such that only an end portion of the electronic device is covered by the retention lid when the retention lid is closed over the electronic device.

9. The retention system of claim 1, wherein an extent to which the one or more molded features extend from the retention lid to the wireless charging pad defines a gap between the retention lid and the wireless charging pad into which the electronic device can be placed.

10. The retention system of claim 9, wherein a height of the gap changes upon contact with the electronic device due to compression of the one or more molded features.

11. A vehicle comprising:
a passenger compartment comprising a center console region; and
a retention system for an electronic device, the retention system embedded in the center console region, the retention system comprising:
a wireless charging pad comprising a charging surface adapted to receive the electronic device, the wireless charging pad configured for wireless power transfer to the electronic device when the electronic device is placed on the charging surface;
a retention lid coupled to the wireless charging pad at a biased hinge, the biased hinge comprising a crossbar and a spring wound around the crossbar, wherein the spring exerts a tension on the retention lid; and
a gripping feature positioned between the retention lid and the wireless charging pad, the gripping feature comprising one or more molded features that extend towards the wireless charging pad, the one or more molded features comprising a material that depresses upon contact with the electronic device.

12. The vehicle of claim 11, wherein the wireless charging pad comprises a first extension feature having a first through hole and the retention lid comprises a second extension feature having a second through hole.

13. The vehicle of claim 12, wherein the crossbar is inserted through the first through hole and the second through hole to rotatably secure the retention lid to the wireless charging pad about the biased hinge.

14. The vehicle of claim 11, wherein, when the retention lid is closed over the electronic device on the wireless charging pad, the retention lid exerts pressure on the electronic device.

15. The vehicle of claim 14, wherein the pressure exerted on the electronic device by the retention lid is proportional to a spring constant of the spring.

16. A method for securing an electronic device when wirelessly charging the electronic device, the method comprising:
providing a wireless charging pad comprising a charging surface adapted to receive the electronic device, the wireless charging pad configured for wireless power transfer to the electronic device when the electronic device is placed on the charging surface;
coupling a retention lid to the wireless charging pad at a biased hinge, the biased hinge comprising a crossbar and a spring wound around the crossbar, wherein the spring exerts a tension on the retention lid; and
positioning a gripping feature between the retention lid and the wireless charging pad, the gripping feature comprising one or more molded features that extend towards the wireless charging pad, the one or more molded features comprising a material that depresses upon contact with the electronic device.

17. The method of claim 16, wherein the wireless charging pad comprises a first extension feature having a first through hole and the retention lid comprises a second extension feature having a second through hole.

18. The method of claim 17, wherein the crossbar is inserted through the first through hole and the second through hole to rotatably secure the retention lid to the wireless charging pad about the biased hinge.

19. The method of claim 16, wherein, when the retention lid is closed over the electronic device on the wireless charging pad, the retention lid exerts pressure on the electronic device.

20. The method of claim 19, wherein the pressure exerted on the electronic device by the retention lid is proportional to a spring constant of the spring.
